(19) United States
(12) Patent Application Publication
(10) Pub. No.: US 2006/0079132 A1
(43) Pub. Date: Apr. 13, 2006

(54) Card reader apparatus

(76) Inventor: Sheng-Ching Ko, Chung Ho City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/962,529

(22) Filed: Oct. 13, 2004

(51) Int. Cl. H01R 24/00

(52) U.S. Cl. 439/630

(57) ABSTRACT

A card reader apparatus is additionally provided with a lifting mechanism, thereby protecting the signal terminals which are not in use, yet allowing electrical contact with the signal terminals that are in use. It comprises an insulation housing having a pivotally jointing portion formed in a card insertion space, a plurality of signal terminal sets disposed on the module substrate, and a lifting mechanism including a lifting plate and elastic components. The lifting plate with a receiving space is pivotally attached to the pivotally jointing portions at one end of the lifting plate. The elastic components are arranged between the lifting plate and the insulation housing. One of the signal terminal sets has its respective contact portions corresponding to the receiving space, and the other of the signal terminal sets has its respective tip portions corresponding to the other end of the lifting plate.

### BACKGROUND OF THE INVENTION

1. Field of the Invention

This invention refers to a card reader apparatus, and more particularly to a card reader apparatus that is additionally equipped with a lifting mechanism, so that the signal terminals are protected when an electrical card is inserted.

2. Description of the Prior Art

A card reader is used to receive and connect with an electrical card, in order to deliver information between the electrical card and an electrical device. There currently exist many different kinds of electrical cards of different sizes. Thereby, many kinds of corresponding card reading devices have been created, such as a multi-in-one type card-reading device, in which many different kinds of electrical cards can be used.

A conditional multiple-card reader apparatus can be connected with a plurality of electrical cards. Accordingly it needs to provide the corresponding plurality of signal terminal sets in such a manner that the different signal terminal sets are seperated from each other, thereby providing electrical contact with the respective types of electrical card.

Although the conditional multiple-card reader apparatus successfully reads electrical cards, there is the potential risk that, due to the front to back staggered arrangement of these signal terminal sets, some of the signal terminals inside may be damaged when an electrical card is inserted. For example, for XD terminals to connect with a XD card, their contact portion is at the outmost position (i.e., closest to the entrance into which the electrical card is inserted); for MS terminals to connect with a MS card, their contact portion is at the innermost position; for SD terminals to connect with a SD card, their contact portion is between the above-described contact position and the XD terminals. In other words, these terminal sets are arranged in the following order from the outermost to the innermost: XD contact portion, SD contact portion and MS contact portion. Therefore, when a user inserts an SD card, the leading bottom surface of the SD card may damage the contact portion of the XD terminals. Especially with an MS card with a leading bottom surface of rough saw tooth portion, it is easy to damage the terminals. Furthermore, the contact portion of the MS terminals are located furthest away from the entrance. As a result, when a MS card is inserted, the XD terminals and then the SD terminals may be damaged, resulting in permanent damage on these terminals or bad electrical contact quality.

Accordingly, to overcome the disadvantages of the above-mentioned prior art apparatus, a reasonably and effectively designed card reader apparatus according to this invention is provided.

### SUMMARY OF THE INVENTION

It is an objective of this invention to enable an electrical card, whose contact portion is near the interior of the card reception slot after insertion, to be successfully inserted without damaging the terminals near the exterior, thereby protecting these signal terminals from possible damage and remarkably lengthening their userlife.

In order to achieve the above-mentioned objectives, this invention provides a card reader apparatus, comprising:

a main insulation unit, inside of which is a respective pivotally jointing portion formed at the opposite side of a card insertion space;

a plurality of signal terminal sets disposed on the insulation housing, where a respective signal terminal of the signal terminal sets is provided with a contact portion and tip portions are formed at the endings of the contact portions; and

a lifting mechanism, comprising a lifting plate with a receiving space and elastic components formed between the lifting plate and the insulation housing, wherein both sides of one end of the lifting plate are pivotally attached to the pivotally jointing portion, and the contact portions one of these signal terminal sets corresponds respectively to the receiving space while the contact portions of the other of the signal terminal set corresponds respectively to the other end of the lifting plate.

### BRIEF DESCRIPTION OF THE DRAWINGS

The foregoing aspects and many of the attendant advantages of this invention will be more readily appreciated as the same becomes better understood by reference to the following detailed description when taken in conjunction with the accompanying drawings, wherein:

FIG. 1 is an exploded view of a card reader apparatus according to this invention;

FIG. 2 is another perspective view of the card reader apparatus according to this invention;

FIG. 3 is a perspective view of a lifting mechanism according to this invention, as viewed from the bottom;

FIG. 4 is a partial assembly view of the card reader apparatus according to this invention without its elastic components and insulation plates;

FIG. 5 is another partial assembly view of the card reader apparatus according to this invention with elastic components but without its insulation plates;

FIG. 6 is an assembly view of the card reader apparatus according to this invention (insulation plates not shown);

FIG. 7 is another assembly view of the card reader apparatus according to this invention (insulation plates not shown); and

FIG. 8 is another assembly view of the card reader apparatus according to this invention (insulation plates not shown).

### DETAILED DESCRIPTION OF THE EMBODIMENTS

The features and technological contents of this invention will become apparent in the following detailed description of the invention with reference to the drawing.

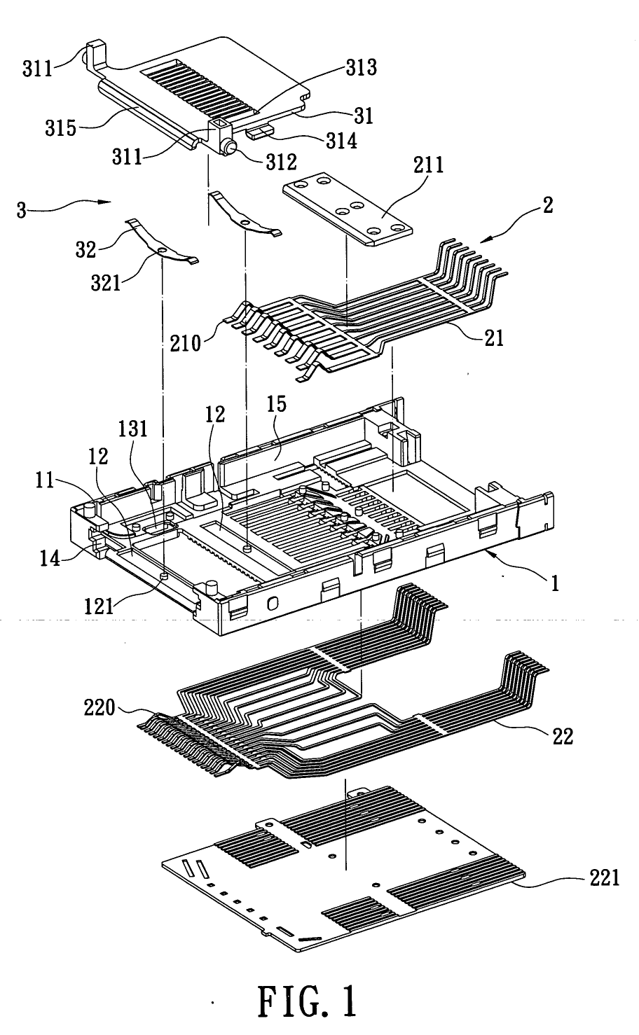

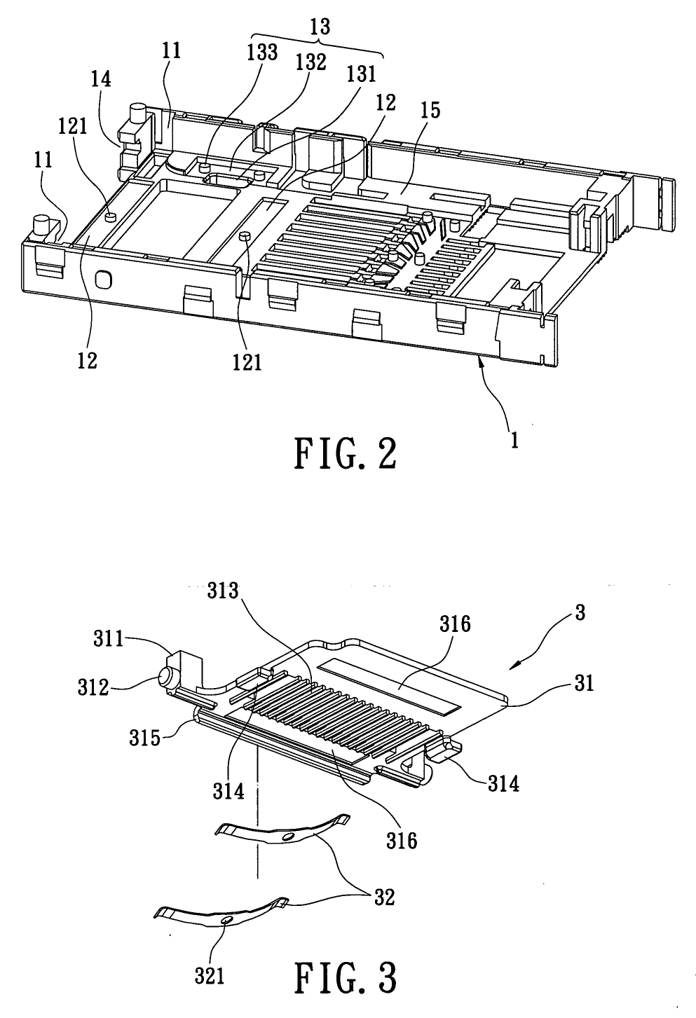

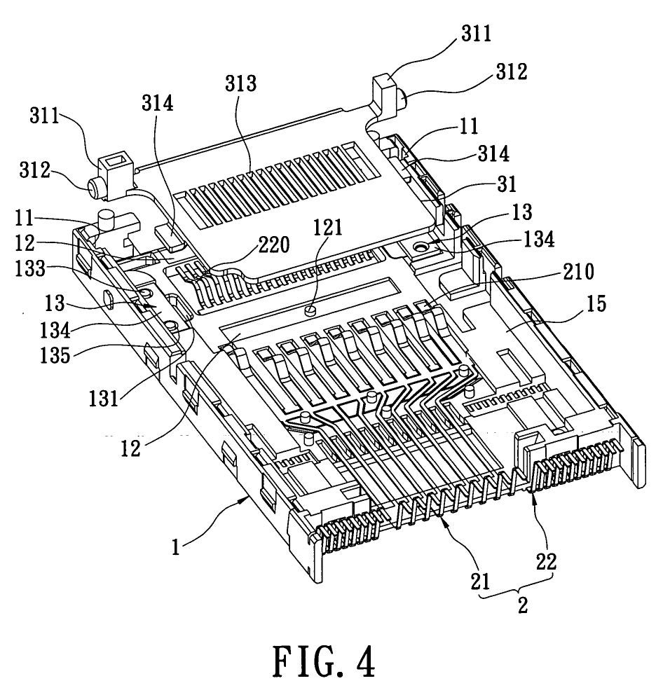

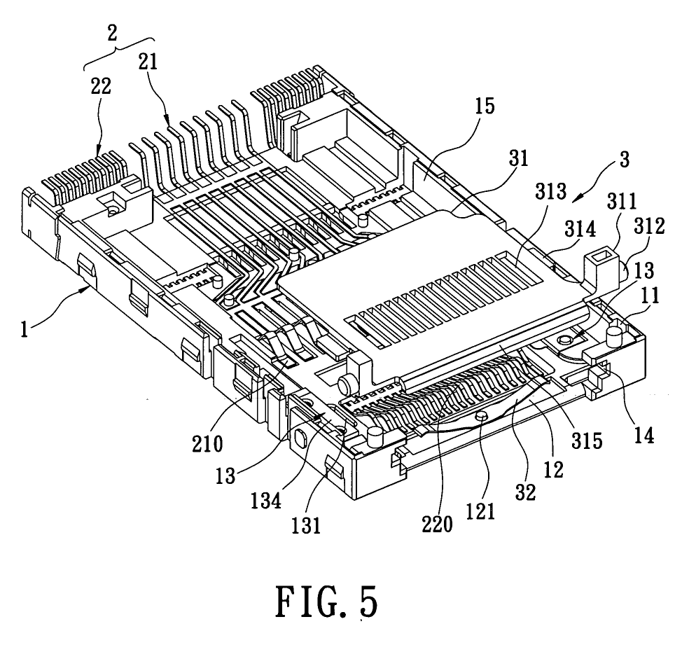

Referring to FIGS. 1 to 6, this invention provides a card reader apparatus used for inserting at least one electrical card to enable the electrical card to transmit information from and to an electrical product, which comprises an insulation housing 1, a plurality of signal terminal sets 2 disposed on the module substrate 1 and a lifting mechanism provided on the insulation housing 1 for protecting these signal terminal sets. It is appreciated that a card withdrawing mechanism is provided inside the insulation housing 1 and at least one metal housing covers the insulation housing 1, which is not shown in these drawings because it is irrelative to the invention.

The insulation housing 1 comprises a card insertion space 15 for inserting a plurality of electrical cards, with one of the sides of the insulation housing 1 has an opening 14 from where electrical card is inserted. The opening 14 is adapted to connect with the card insertion space 15. On the opposite inner walls of the insulation housing 1 adjacent to the opening 14, respective pivotally jointing portions 11 are formed for pivotally attaching to the lifting mechanism 3. The respective pivotally jointing portions 11 are arranged to be fitted into respective recessed grooves with a single open end formed on the inner walls of the insulation housing 1, so as to pivotally attach to the lifting mechanism 3. On the inner surface of the insulation housing 1, a plurality of spacing portions 12 and a plurality of limiting structures 13 are formed, which will be described in detail below.

A plurality of signal terminal sets 2 includes at least a first and second groups of signal terminals 21 and 22, each of them is disposed on the insulation housing 1 and comprises a respective plurality of signal terminals. Each of the signal terminals has a contact portion (for example a contact portion 220 of the second group 22) formed on one end therein and a soldering portion on the other end. Furthermore, the endings of the respective contact portions of the first group 21 are formed with respective tip portions 210. The first group 21 of the signal terminal sets is formed on the inner side of the insulation housing 1, which is fixed in position by an insulation plate 211; the second group 22 of the signal terminal sets is formed on the outer side of the insulation housing 1, which is fixed in position by pressing and retaining by another insulation plate 221. These two insulation plates will not be described further, since they are not features of this invention, and thus are not shown in these drawings except FIG. 1.

The lifting mechanism 3 comprises a lifting plate 31 and a plurality of elastic components 32 formed between the lifting plate 31 and the inner surface of the insulation housing 1. The lifting plate 21 has at least two projecting bodies 311, at least two pivot shafts 312, a receiving space 313, at least two wing portions 314 and a bent portion 315. Each of the respective elastic components 32 is formed with a fixed portion 321.

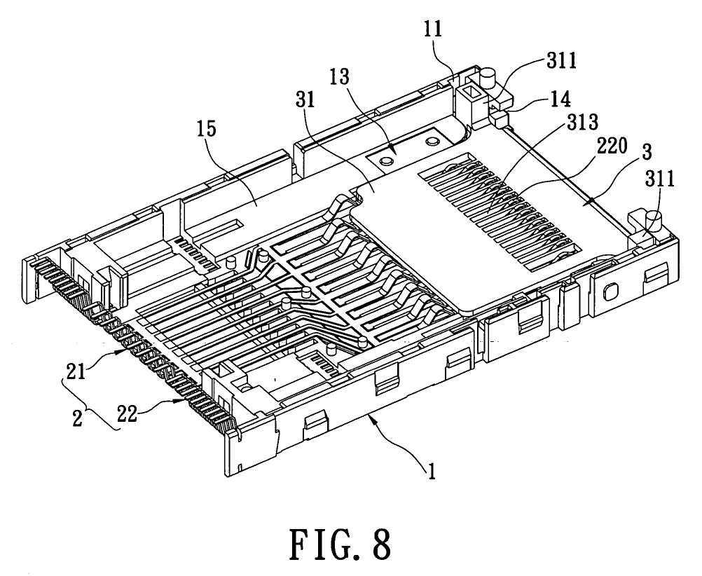

The receiving space 313 is arranged above the lifting plate 31 for receiving the respective contact portions 220 of the second group 22 and may comprise a plurality of slots. The respective slots correspond to the respective contact portions 220 of the second group 22 for receiving these contact portions 220. The end of the lifting plate 31 adjacent to the opening 14 is formed with a bent portion 315 for partitioning and thus guiding the inserted electrical card. The bent portion 315 is arranged to act as a partition across this intended edge of the lifting plate 31 and the corresponding side of the insulation housing 1. Both ends of the intended edges of the lifting plate 31 are formed with respective projecting bodies 311 projecting vertically. The respective projecting bodies 311 themselves have the same height as that of the card insertion space 15 (as shown in FIG. 8), so as to prevent both the pivot shafts 312 from disengaging or displacing out of the respective pivotally jointing portions 11. At the root portions on the opposite outer sides of the projecting bodies 311, a pair of the pivot shafts 312 is arranged to correspond to the pivotally jointing portions 11. By means of the engagement of these two pivot shafts 312 into the corresponding pivot jointing portions 11, the lifting plate 31 is pivotally attached to the insulation housing 1, and thus can swing like a tongue piece. At opposite side edges of the lifting plate 31, respective wing portions 314 are provided, and respective bent sections 315 orientated toward the insulation housing 1 are formed between the respective wing portions 314 and the lifting plate 31, respectively.

Two limiting structures 13 are formed to be opposite to the respective wing portions 314 on the inner surface of the insulation housing 1. Each of the limiting structures 13 comprises a groove 131 formed on the insulation housing 1 to accommodate the wing portion 314 for insertion and ejection, a position fixed portion formed around the groove 131, a plurality of fixing bodies 133 formed on the position fixed portion 132 and a stop body 134 fixed by the position fixed portion 132. Each of the stop bodies 134 are formed with a fixed portion 135, which are opposite respective fixing bodies 133. The bond between the fixing bodies 133 and the fixed portions 135 may be made by means of retaining, riveting or fusion methods, so that the stop bodies 134 can be fixed by respective fixing bodies 133. Furthermore, by means of the portion fixed portions 132, the stop bodies 134 are partially presented above the grooves 131 and these two wing portions 314 of the lifting plate 31 are limited by the stop bodies 134, so as to move within the grooves 131, thereby enabling the swing movement by the lifting plate (similar to that done by a tongue piece) to be limited within a certain range and the bent sections jointing between the lifting plate 31 and the respective wing portions 314 to move in or out at the position of the groove where the bent sections are partially presented.

On the inner surface of the insulation housing 1 and the surface of the lifting plate 31 facing and touching the insulation housing 1, at least two first spacing portions 12 and at least two second spacing portion 316 are formed, respectively, in such manner that these first and second spacing portions 12 and 316 are opposite to each other. Furthermore a fixing body 121 is provided inside the first spacing portion 12. The respective elastic components 32 are fixed to the first spacing portions 12, wherein the bond between the fixed portions 321 of the elastic component 32 and the fixing body 121 may be made by means of retaining, riveting or fusion methods (similar to the above-mentioned fixation between the fixing body 133 and the fixed portion 135). In addition, both the tip portions of the elastic components 32 are arranged to be brought into contact with the second spacing portion 316, so that the lifting plate 31 can swing elastically similar to a tongue piece. In this way, a card reader according to this invention is provided.

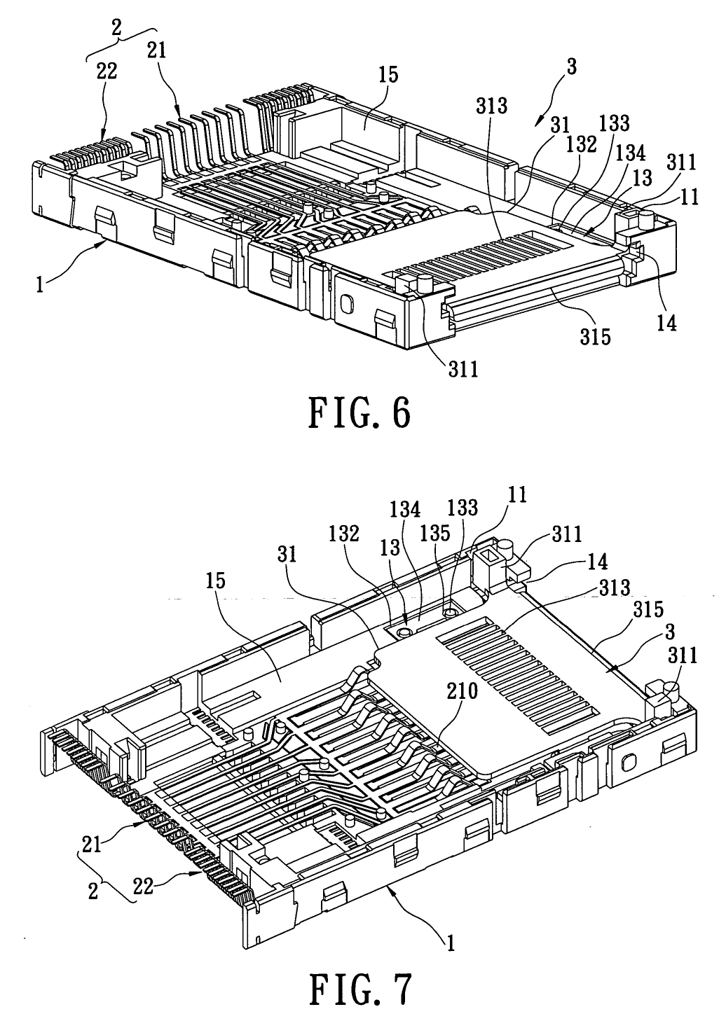

Referring to FIGS. 6 or 7, the receiving space 313 of the lifting plate 31 corresponds to the respective contact portions 220 of the second group 22, and the other side of the lifting plate 31 at the same end corresponds to the respective ending portion 210 of the first group 21. In this way, when the lifting plate 31 of the lifting mechanism 3 is lifted by the elastic components 32 and thus in a free state, the signal terminals of the first and second groups 21 and 22 (for example, the SD and XD terminals, respectively) can be protected from damage by an inserted electrical card (for example, MS card).

Referring to FIG. 8, when an electrical card which is near to the exterior is inserted (for example, a XD card, whose terminals are the second group 22 as shown in the drawing) is inserted, the electrical card elastically pushes down the lifting plate 31 of the lifting mechanism 3, so that the respective contact portions 220 of the second group 22 are exposed inside the receiving space 313, thereby enabling the contact points of the electrical card (XD card) to connect therewith. Moreover, after the other end of the lifting plate 31 is pushed down it applies pressure on the respective ending portions 210 of the first group 21, so as to enable the respective signal terminals of the first group 21 to function in a pre-load form.

The insulation plates 211 and 221 are bonded to the insulation housing 1 in the same way as the bond to the stop body 134 or the elastic components 32, which are made by retaining, riveting or fusion methods, thus corresponding hole-shaped fixed portions (not shown) and rob-shaped fixing bodies (not shown) are provide.

It is appreciated that the first and second groups 21 and 22 are taken as an example of the signal terminal sets 2, as shown in the drawings, the signal terminals are illustrated together with carrier tapes which will be cut during manufacturing.

According to the structure of this invention, since the card reader apparatus of this invention is provided with a lifting mechanism 3, these signal terminals whose contact positions are near the exterior (for example, XD and SD terminals) can be protected from damage during the insertion of electrical cards whose contact positions are near the interior (for example, MS cards). Meanwhile the protected signal terminals have to be brought into electrical contact, the electrical contact operation can be accomplished by means of the lifting mechanism 3, thereby protecting these signal terminals from possible damage, maintaining a good electrical contact quality with the electronic card and remarkably lengthening their user life. Furthermore, the lifting mechanism 3 can be used to press the signal terminals (for example, SD terminals).

In conclusion, this invention provides a card reader that can substantially overcome the significant disadvantages of the prior art and obtain the enhancement in function.

Therefore, the application is proposed according to patent law, it is desired that the invention will be obtained early, to protect the rights of the inventor.

As described above, while the techniques and means have been disclosed above merely as preferred embodiments of this invention, it is not intended to limit the scope of this invention. It will be appreciated that any equivalent structural changes made to the contents of the specification and the drawings fall within the spirit and scope of this present invention.

What is claimed is:

1. A card reader apparatus comprising:
an insulation housing, inside of which a respective pivotally jointing portion is formed at opposite sides of a card insertion space;
a plurality of signal terminal sets disposed on the insulation housing, each of the signal terminal sets having a plurality of signal terminals, each of the signal terminals having a contact portion and tip portions formed at the endings of the contact portion; and
a lifting mechanism, comprising a lifting plate with a receiving space and elastic components formed between the lifting plate and the insulation housing, wherein both sides of one end of the lifting plate are pivotally attached to the respective pivotally jointing portion, and each of the contact portions of one of signal terminal sets corresponding to the receiving space, and each of the tip portions of another of signal terminal sets corresponding to the other end of the lifting plate.

2. The card reader apparatus according to claim 1, wherein the lifting plate of the lifting mechanism is further formed with respective pivot shafts at each side of one end thereof, respectively, which are pivotally attached to the respective pivotally jointing portions.

3. The card reader apparatus according to claim 2, wherein the lifting plate of the lifting mechanism further has respective projecting bodies attached between each of the respective pivot shafts and the lifting plate, wherein the respective projecting bodies have the same height as that of the card insertion space.

4. The card reader apparatus according to claim 1, wherein the edge of the lifting plate of the lifting mechanism at which the lifting plate is pivotally arranged to be adjacent to an opening of the insulation housing and is further formed with a bent portion, wherein the bent portion acts as a partition across the edge of the lifting plate and the corresponding side of the insulation housing.

5. The card reader apparatus according to claim 1, wherein the lifting plate of the lifting mechanism is further formed with two wing portions, and two limiting mechanisms are formed at the corresponding positions on the insulation housing, wherein the two wing portions move with respect to the limit of these liming mechanisms.

6. The card reader apparatus according to claim 5, wherein these limiting mechanisms of the insulation housing comprise a respective groove formed on the insulation housing and a respective stop body partially buried in the respective groove, wherein the respective stop body is fixed to the insulation housing, and these two wing portions of the lifting plate are bent to be placed into the corresponding grooves and are limited by the stop bodies.

7. The card reader apparatus according to claim 1, wherein a plurality of first and second spacing portions are formed respectively on the surface of the lifting plate 31 facing and touching the insulation housing 1 and the inner surface of the insulation housing 1, wherein the elastic components of the lifting mechanism are fitted into the respective first spacing portions and the tip portions of the respective components are brought into contact with the respective second spacing portions.

8. The card reader apparatus according to claim 1, wherein the lifting plate of the lifting mechanism has a plurality of slots on the receiving space thereof, each of the slots corresponding to the corresponding contact portions of the signal terminal sets.
